(19) United States
(12) Patent Application Publication
(10) Pub. No.: US 2016/0095678 A1
(43) Pub. Date: Apr. 7, 2016

(54) TAPE DENTAL FLOSS

(71) Applicant: Ruairidh Robertson, Sandwich, MA (US)

(72) Inventor: Ruairidh Robertson, Sandwich, MA (US)

(21) Appl. No.: 14/875,892

(22) Filed: Oct. 6, 2015

Related U.S. Application Data
(60) Provisional application No. 62/060,720, filed on Oct. 7, 2014.

(51) Int. Cl. A61C 15/04

(52) U.S. Cl. CPC A61C 15/042

(57) ABSTRACT

In at least one embodiment, dental floss is provided comprising a floss tape comprising a flossing strip, the flossing strip having opposing longitudinal side faces and opposing longitudinal edges, and a plurality of flossing elements formed along at least one of the longitudinal edges. In at least one embodiment, dental floss is provided comprising a floss tape comprising a flossing strip, the flossing strip having opposing longitudinal side faces and opposing longitudinal edges, and at least one side flossing fin extending laterally outwardly from at least one of the longitudinal side faces of the flossing strip.

### CROSS REFERENCE TO RELATED APPLICATION

This application claims the benefit of U.S. Provisional Application Ser. No. 62/060,720, filed Oct. 7, 2014, the entire disclosure of which is fully incorporated herein by reference.

### FIELD

The present disclosure relates generally to personal hygiene products and, more particularly, to tape dental floss for cleaning teeth.

### BACKGROUND

Dental floss is generally available as a cylindrical filament, and a planar tape of uniform width. Filament dental floss may be a multifilament floss or of a monofilament floss (i.e. single filament).

Filament dental floss is often difficult to get between closely packed teeth due to its diameter. Also filament dental floss, and in particular multifilament floss, while potentially being more effective at removing plaque, may be uncomfortable when used by certain individuals due to its surface texture. Further, due to the relatively low surface area, cleaning teeth with filament dental floss can take a relatively long period of time to clean the teeth surfaces.

Tape dental floss, which may be referred to simply as “dental tape”, offers an alternative to filament dental floss. Tape dental floss may be thinner than filament dental floss, thus making it easier to insert between closely packed teeth. The tape may also offer a smoother texture than multifilament floss making it more comfortable for use. Furthermore, the greater cleaning surface area of tape dental floss as compared to filament dental floss may decrease the time necessary to clean teeth. However, a further improvement in tape dental floss would be to further increase the cleaning effectiveness of the in tape dental floss.

### FIGURES

The above-mentioned and other features of this disclosure, and the manner of attaining them, will become more apparent and better understood by reference to the following description of embodiments described herein taken in conjunction with the accompanying drawings, wherein:

FIG. 1 is a perspective view of dental floss tape according to a first embodiment of the present disclosure;

FIG. 2 is a side view of the dental floss tape of FIG. 1;

FIG. 3 is an end view of the dental floss tape of FIG. 1;

FIG. 4A is side view of another embodiment of dental floss tape according to the present disclosure;

FIG. 4B is side view of another embodiment of dental floss tape according to the present disclosure;

FIG. 4C is side view of another embodiment of dental floss tape according to the present disclosure;

FIG. 4D is side view of another embodiment of dental floss tape according to the present disclosure;

FIG. 4E is side view of another embodiment of dental floss tape according to the present disclosure;

FIG. 4F is side view of another embodiment of dental floss tape according to the present disclosure;

FIG. 4G is side view of another embodiment of dental floss tape according to the present disclosure;

FIG. 4H is side view of another embodiment of dental floss tape according to the present disclosure;

FIG. 4I is side view of another embodiment of dental floss tape according to the present disclosure;

FIG. 4J is side view of another embodiment of dental floss tape according to the present disclosure;

FIG. 4K is side view of another embodiment of dental floss tape according to the present disclosure;

FIG. 4L is side view of another embodiment of dental floss tape according to the present disclosure

FIG. 5 is a perspective view of dental floss tape according to another embodiment of the present disclosure;

FIG. 6 is a side view of the dental floss tape of FIG. 5;

FIG. 7 is an end view of the dental floss tape of FIG. 5;

FIG. 8A is an end view of another embodiment of dental floss tape according to the present disclosure;

FIG. 8B is an end view of another embodiment of dental floss tape according to the present disclosure;

FIG. 8C is an end view of another embodiment of dental floss tape according to the present disclosure;

FIG. 8D is an end view of another embodiment of dental floss tape according to the present disclosure;

FIG. 8E is an end view of another embodiment of dental floss tape according to the present disclosure;

FIG. 8F is an end view of another embodiment of dental floss tape according to the present disclosure;

FIG. 8G is an end view of another embodiment of dental floss tape according to the present disclosure;

FIG. 8H is an end view of another embodiment of dental floss tape according to the present disclosure; and

FIG. 8I is an end view of another embodiment of dental floss tape according to the present disclosure.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

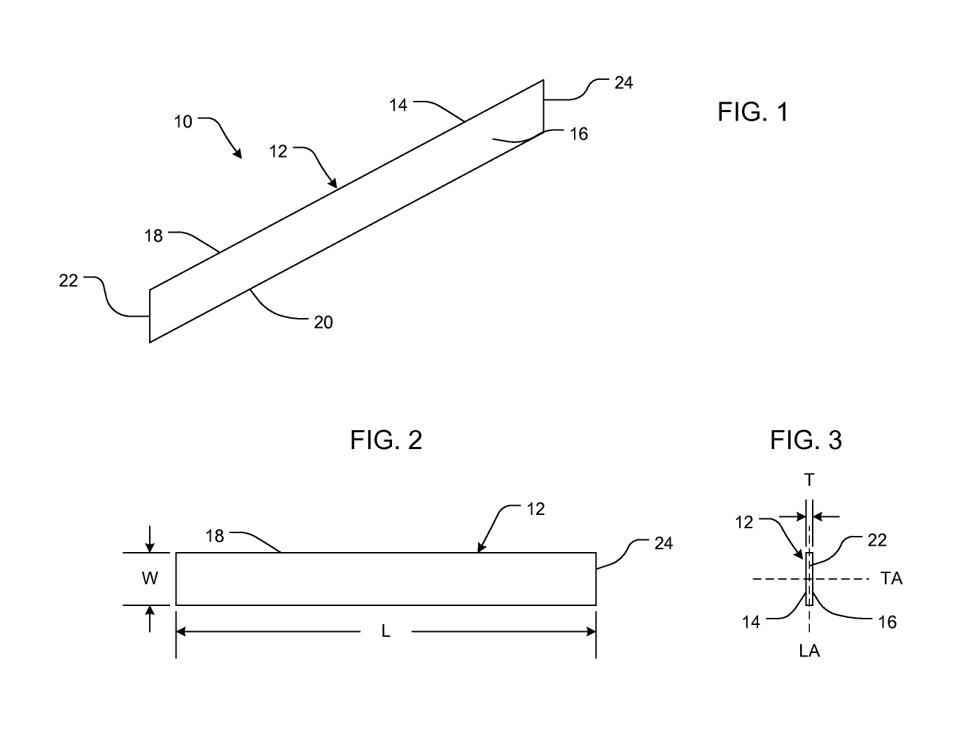

Referring now to the figures, FIGS. 1-3 show dental cleaning floss in the form of a thin, elongated dental floss tape 10. As shown, floss tape 10 comprises a planar flossing strip 12 having opposing longitudinal side faces 14, 16, opposing upper and lower longitudinal edges 18, 20, and opposing front and rear edges 22, 24.

It should be understood that spatially relative terms, such as “upper,” “lower” “forward,” “rear” and the like are used herein for ease of description to describe one element or feature's relationship to another element(s) or feature(s) as illustrated in the drawings. These spatially relative terms are intended to encompass different orientations of the floss tape 10 in use or operation in addition to the orientation shown in the drawings. For example, the floss tape 10 is described herein as having an “upper edge” and a “lower edge” as shown in the drawings is expected to be inverted when inserted between teeth, in which case the “upper edge” would be closest to the gum line.

Flossing strip 12 also comprises a length L, a width W and a thickness T, with the length L being substantially greater than the width W, and the width W being substantially greater than the thickness T. More particularly, the length L may be in a range of 0.5 inches to 50 feet (e.g. a 50 foot roll length), the width W may be in a range of 0.1 inch to 0.25 inch, and the thickness may be in a range of 0.001 inch to 0.01 inch. Flossing strip 12 also comprises a longitudinal axis LA which extends parallel with the thickness T of the flossing strip 12, and a transverse axis TA which is perpendicular to the longitudinal axis LA.

Flossing strip 12 may be made of a plastic composition including at least one thermoplastic polymer, such a polyamide (PA) or polytetrafluoroethylene (PTFE). Flossing strip 12 may be manufactured using an extrusion process. After extrusion of flossing strip 12, the flossing strip 12 may be trimmed or otherwise cut in such a manner (such as by a laser, water jet or mechanical blade) as to provide a series of flossing elements formed along a length of the flossing strip as disclosed herein. Thereafter, the flossing strip 12 may be wound into the form of a roll.

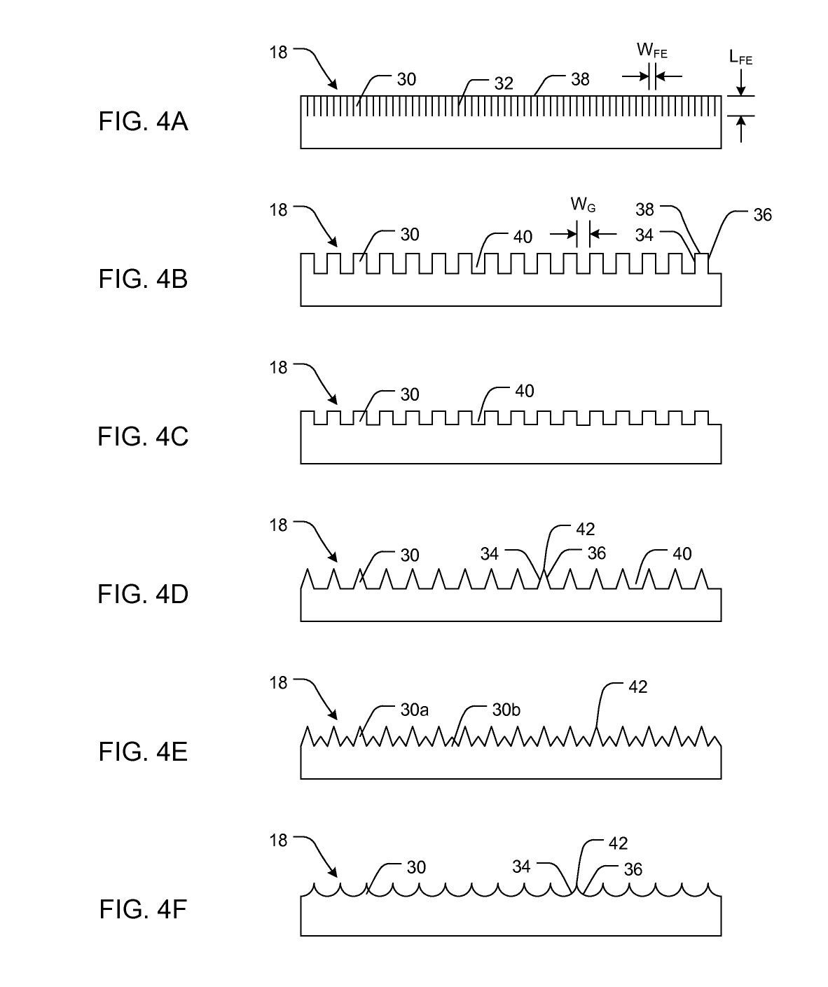

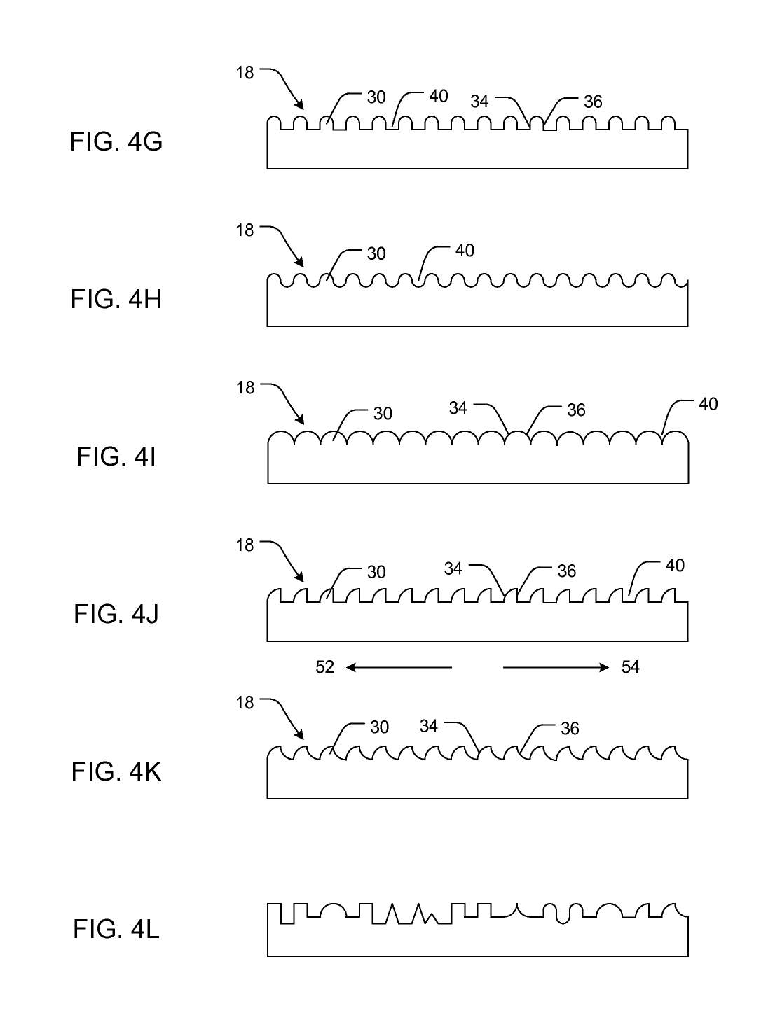

Referring now to FIGS. 4A-4L, flossing strip 12 may include a plurality of discrete flossing elements 30 along the upper edge 18 and/or lower edge 20, which are shown to comprise a continuous row of individually formed teeth. While the flossing elements 30 are only shown along the upper edge 18, the flossing elements 30 may be equally located along the lower edge 20, such that both the upper edge 18 and the lower edge 20 may include flossing elements 30 to clean teeth. Alternatively, the lower edge 20 may simply be a continuous straight edge as shown.

As shown in FIG. 4A, the flossing elements 30 may be separated by a narrow cut line 32 (as may be formed by a laser, water jet or cutting blade, such as a razor blade). In the foregoing manner, due to the narrow cut line 32, adjacent flossing elements 30 may make contact with one another along their front edges 34 and rear edges 36 (see FIG. 4B) to simulate a continuous straight edge along upper edge 18.

As shown, flossing elements 30 may have a rectangular shape, with a blunt outer edge 38. Also as shown, front edges 34, rear edges 36 and outer edge 38 of flossing elements 30 are substantially straight edges, with the intersection of the front edges 34 and rear edges 36 with the outer edges 38 particularly being formed at a right angle.

In such a manner, two sharp corners may be provided at the front edge 34 and rear edge 36 of each flossing element 30 to aid in the cleaning of teeth when the floss tape 10 is manipulated. The flossing elements 30 may have a flossing elements length L in a range of 0.05 inch to 0.15 inch, and a flossing elements width W_{FE} of 0.1 inch to 0.6 inch.

As shown in FIG. 4B, the flossing elements 30 may be separated by a separation gap 40 which inhibits the front edge 34 and rear edge 36 of adjacent flossing elements 30 from making contact with one another, such that the full length of the front edge 34 and rear edge 36 may be better used to clean teeth.

The separation gap 40 may have a gap width W_{G} in a range of 0.1 inch to 0.6 inch. Similar to FIG. 4A, front edges 34, rear edges 36 and outer edges 38 of flossing elements 30 are substantially straight, and the intersection of the front edges 34 and rear edges 36 with the outer edges 38 are formed at a right angle, with the flossing elements 30 having the same dimensions as the embodiment of FIG. 4A.

As shown in FIG. 4C, the flossing elements 30 may have a square shape as opposed to having a rectangular shape as shown in FIG. 4A and FIG. 4B. The flossing elements 30 and separation gap 40 of FIG. 4C may be the same in all other respects with the flossing elements of FIG. 4B.

As shown in FIG. 4D, the flossing elements 30 may have a triangular shape. As shown, the front edge 34 and rear edge 36 of each of the flossing elements 30 are substantially straight, with the front edge 34 and rear edge 36 terminating in a pointed tip 42. Also as shown, as opposed to the separation gap 40 having a rectangular or square shape (FIGS. 4C and 4D, respectively), the separation gap 40 narrows along the length of the separation gap 40 from the pointed tip 42 of the flossing element 30 to the bottom of the flossing element 30. The pointed tip 42 of the flossing element 30 may be easier to get into particularly narrow or small locations between teeth.

As shown in FIG. 4E, the flossing elements 30 may have a triangular shape and a pointed tip 42, and further have different lengths with shorter flossing elements 30b being located between taller flossing elements 30a.

As shown in FIG. 4F, the flossing elements 30 may have a reverse scalloped shape with pointed tip 42. As shown, the front edges 34 and rear edges 36 of flossing elements 30 each comprise a concave quarter-spherical shape (i.e. a spherical edge having a radial arc of about 90 degrees). In the foregoing manner, the pointed tip 42 of the flossing element is extremely narrow, and thus it may be easier to get into particularly narrow or the smallest locations between teeth.

As shown in FIG. 4G, the front edges 34 and rear edges 36 of flossing elements 30 may comprise a straight edge near the bottom of the flossing elements 30 which then transitions to a convex quarter-spherical shape, resulting in a continuous hemi-spherical edge (i.e. a spherical edge having a radial arc of about 180 degrees) along the upper portion of the flossing elements 30. The hemi-spherical portion may be particularly beneficial to individuals who cannot use the embodiments of the floss tap with sharp corners or pointed tips.

As shown in FIG. 4H, the bottom of gap 40 between flossing elements 30 may be spherical, and more particularly a hemi-spherical to make the transition between the flossing elements as smooth as possible.

As shown in FIG. 4I, the flossing elements 30 may have a spherical shape, and more particularly a hemi-spherical shape, with only a very narrow gap 40 or no gap 40 between them. As shown, the front edges 34 and rear edges 36 of flossing elements 30 each have a convex quarter-spherical shape, resulting in a continuous hemi-spherical edge (i.e. a spherical edge having a radial arc of about 180 degrees). In the foregoing manner, the size of the spherical shape may be increased as compared to the embodiments of FIG. 4G and FIG. 4H.

As shown in FIG. 4J, the flossing elements 30 may have a quarter-sphere shape, as opposed to a hemi-spherical shape, with the front edges 34 having a convex quarter-spherical shape and rear edge 36 being straight. Because the front edge 34 and rear edge 36 are not mirror images of one another, the flossing elements may clean teeth in a different manner when the floss tape 10 is moved in opposite longitudinal directions 52 and 54 between teeth, as opposed to certain other embodiments where teeth cleaning in opposite directions 52 and 54 may be substantially the same in light of the front edge 34 and rear edge 36 of the flossing elements 30 being mirror images of one another. With the present embodiment, the contour of flossing elements 30 may be arranged to loosen plaque between teeth when moved in one longitudinal direction and extract the plaque from between the teeth in the other longitudinal direction.

As shown in FIG. 4K, in contrast to FIG. 4J, the flossing elements 30 have a front edge 34 with a convex quarter-spherical shape and a rear edge 36 with a concave quarter-spherical shape. This may further aid to loosen plaque between teeth when the flossing elements 30 are moved in one longitudinal direction, and extract the plaque from between the teeth when the flossing elements 30 are moved in the opposite longitudinal direction.

As shown in FIG. 4L, any one of the preceding flossing elements 30 of any embodiment may be combined with flossing elements 30 of other embodiments.

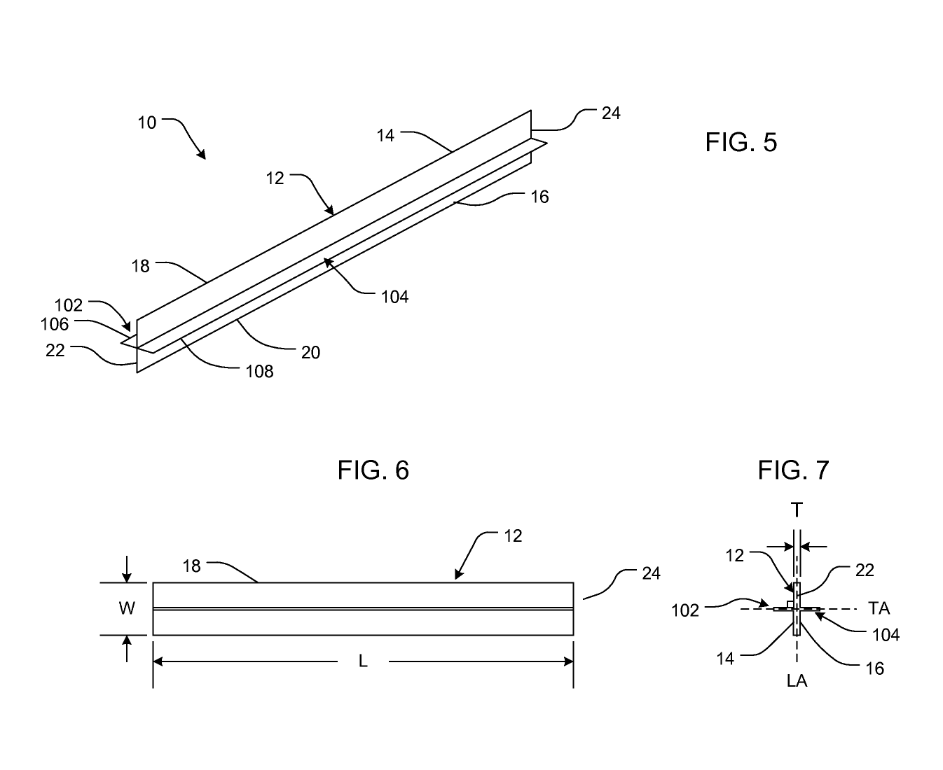

Referring now to FIGS. 5-7, in at least one embodiment, floss tape 10 may include laterally extending side flossing fin 102 and/or side flossing fin 104 extending laterally outwardly from the side faces 14, 16 of the flossing strip 12. Similar to the flossing elements 30 formed along the upper edge 18 and/or lower edge 20 of the flossing strip 12, the side flossing fins 102, 104 may also be used to better clean teeth. Furthermore, to further increase cleaning ability the outer longitudinal edges 106, 108 of the flossing fins 102, 104, any of the foregoing flossing elements 30 may be included along the outer longitudinal edges 106, 108.

As shown in FIG. 7, floss tape 10 includes one side flossing fin 102 which extends laterally outwardly from side face 14 of the flossing strip 12 at a right angle relative to the width W of the flossing strip 12, as well as one side flossing fin 104 which extends laterally outwardly from side face 16 of the flossing strip 12 at a right angle relative to a width W of the flossing strip 12.

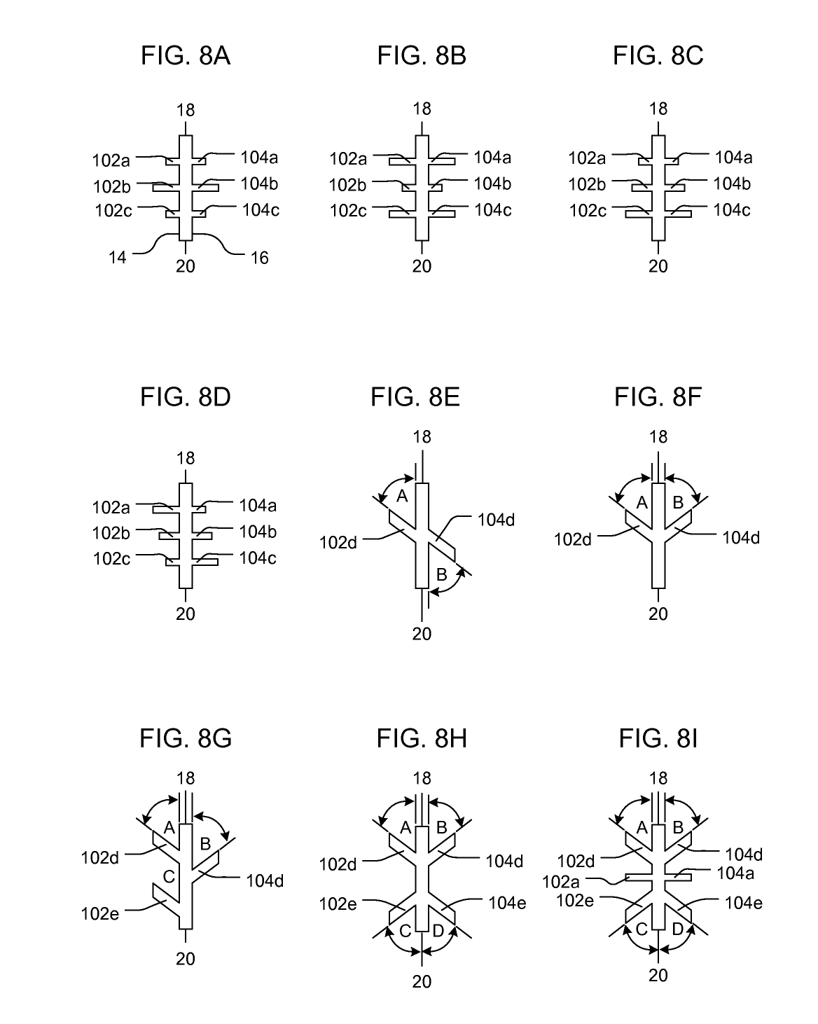

As shown in FIGS. 8A-8D, floss tape 10 includes a plurality of side flossing fins 102a, 102b, and 102c which extend laterally outwardly from side face 14 of the flossing strip 12 at a right angle relative to the width W of the flossing strip 12. In addition, floss tape 10 includes a plurality of side flossing fins 104a, 104b, 104b which extends laterally outwardly from side face 16 of the flossing strip 12 at a right angle relative to a width W of the flossing strip 10.

In FIG. 8A, on side face 14, intermediate flossing fin 102b is taller (longer) than upper flossing fin 102a and lower flossing fin 102c, which may be equal in height. Similarly, on side face 16, intermediate flossing fin 104b is taller than upper flossing fin 104a and lower flossing fin 104c, which may be equal in height.

In FIG. 8B, on side face 14, intermediate flossing fin 102b is shorter than upper flossing fin 102a and lower flossing fin 102c, which may be equal in height. Similarly, on side face 16, intermediate flossing fin 104b is shorter than upper flossing fin 104a and lower flossing fin 104c, which may be equal in height.

In FIG. 8C, on side face 14, upper flossing fin 102a may be shorter than intermediate flossing fin 102b, which may be shorter than lower flossing fin 102c. Similarly, on side face 16, upper flossing fin 104a may be shorter than intermediate flossing fin 104b, which may be shorter than lower flossing fin 104c.

In FIG. 8D, on side face 14, upper flossing fin 102a may be taller than intermediate flossing fin 102b, which may be taller than lower flossing fin 102c. On side face 16, upper flossing fin 104a may be shorter than intermediate flossing fin 104b, which may be shorter than lower flossing fin 104c.

In FIG. 8E, on side face 14, flossing fin 102d extends laterally outwardly from side face 14 of the flossing strip 12 at an acute angle A relative to the upper edge 18 of the flossing strip 12. On side face 16, flossing fin 104d extends laterally outwardly from side face 16 of the flossing strip 12 at an acute angle B relative to the lower edge 20 of the flossing strip 12. Angle A and Angle B may be in a range of 1 degree to 89 degrees, and may be the same or may be different.

In FIG. 8F, on side face 14, flossing fin 102d extends laterally outwardly from side face 14 of the flossing strip 12 at an acute angle A relative to the upper edge 18 of the flossing strip 12. On side face 16, flossing fin 104d extends laterally outwardly from side face 16 of the flossing strip 12 at an acute angle B relative to the upper edge 18 of the flossing strip 12. Angle A and Angle B may be in a range of 1 degree to 89 degrees, and may be the same or may be different.

In FIG. 8G, on side face 14, flossing fins 102d and 102e extend laterally outwardly from side face 14 of the flossing strip 12 at an acute angles A and C, respectively, relative to the upper edge 18 of the flossing strip 12. On side face 16, flossing fin 104d extends laterally outwardly from side face 16 of the flossing strip 12 at an acute angle B relative to the upper edge 18 of the flossing strip 12. Angles A, B and C may be in a range of 1 degree to 89 degrees, and may be the same or may be different.

In FIG. 8H, on side face 14, flossing fin 102d extends laterally outwardly from side face 14 of the flossing strip 12 at an acute angle A relative to the upper edge 18 of the flossing strip 12, while flossing fin 102e extends laterally outwardly from side face 14 of the flossing strip 12 at an acute angle C relative to the lower edge 18 of the flossing strip 12.

On side face 16, flossing fin 104d extends laterally outwardly from side face 16 of the flossing strip 12 at an acute angle B relative to the upper edge 18 of the flossing strip 12, while flossing fin 104e extends laterally outwardly from side face 16 of the flossing strip 12 at an acute angle D relative to the lower edge 18 of the flossing strip 12.

In FIG. 8I, in contrast to FIG. 8H, on side face 14, an intermediate fin 102a extends laterally outwardly from side face 14 of the flossing strip 12 at a right angle relative to the width W of the flossing strip 12, while on side face 16, an intermediate fin 104a extends laterally outwardly from side face 16 of the flossing strip 12 at a right angle relative to the width W of the flossing strip 12.

As set forth herein, the side flossing fins may also be used to better clean teeth, as compared to planar strip 12 alone. The relative height and angle of the side flossing fins may be varied as required to effect cleaning.

According to one aspect, the present disclosure provides a dental floss, particularly in the form of a floss tape, which may offer improved cleaning of teeth. In particular, the floss tape may comprise a flossing strip including a plurality of flossing elements formed along at least one of the longitudinal edges thereof. The geometry of the flossing elements may be used to better assist in the cleaning of teeth as compared to floss tape which does not include the flossing elements.

In at least one embodiment, a floss tape is provided comprising a flossing strip, the flossing strip having opposing longitudinal side faces and opposing longitudinal edges, and a plurality of flossing elements formed along at least one of the longitudinal edges.

The floss tape may also comprise a flossing strip including at least one side flossing fin extending laterally outwardly from at least one of the longitudinal side faces of the flossing strip. Similarly, the geometry of the flossing fin(s) may be used to better assist in the cleaning of teeth as compared to floss tape which does not include the flossing fin(s) extending laterally outwardly from at least one of the longitudinal side faces of the flossing strip.

In at least one embodiment, a floss tape is provided comprising a flossing strip, the flossing strip having opposing longitudinal side faces and opposing longitudinal edges, and at least one side flossing fin extending laterally outwardly from at least one of the longitudinal side faces of the flossing strip.

In at least one embodiment, then floss tape may include a plurality of flossing elements formed along at least one of the longitudinal edges of the floss strip, and at least one side flossing fin extending laterally outwardly from at least one of the longitudinal side faces of the flossing strip.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. Dental floss comprising:
a floss tape comprising a flossing strip, the flossing strip having opposing longitudinal side faces and opposing longitudinal edges, and a plurality of flossing elements formed along at least one of the longitudinal edges of the flossing strip.

2. The dental floss of claim 1 wherein:
at least one flossing element of the plurality of flossing elements has a rectangular shape, a square shape or a triangular shape.

3. The dental floss of claim 1 wherein:
at least one flossing element of the plurality of flossing elements has s blunt outer edge.

4. The dental floss of claim 1 wherein:
at least one flossing element of the plurality of flossing elements has a pointed tip.

5. The dental floss of claim 1 wherein:
at least one flossing element of the plurality of flossing elements has a spherical edge.

6. The dental floss of claim 1 wherein:
the spherical edge comprises a radial arc of at least about 90 degrees.

7. The dental floss of claim 1 wherein:
the spherical edge comprises a radial arc of about 180 degrees.

8. The dental floss of claim 1 wherein:
the spherical edge is a convex spherical edge.

9. The dental floss of claim 1 wherein:
the spherical edge is a concave spherical edge.

10. The dental floss of claim 1 wherein:
at least one flossing element of the plurality of flossing elements has a convex spherical first edge and a concave spherical second edge.

11. The dental floss of claim 1 wherein:
the floss tape comprises at least one side flossing fin extending laterally outwardly from at least one of the longitudinal side faces of the flossing strip.

12. The dental floss of claim 11 wherein:
at least one side flossing fin extending laterally outwardly from at least one of the longitudinal side faces of the flossing strip extends laterally at a right angle relative to a width of the flossing strip.

13. The dental floss of claim 11 wherein:
at least one side flossing fin extending laterally outwardly from at least one of the longitudinal side faces of the flossing strip extends laterally at an acute angle relative to a longitudinal edge of the flossing strip.

14. The dental floss of claim 1 wherein:
the floss tape comprises a plurality of flossing fins extending laterally outwardly from at least one of the longitudinal side faces of the flossing strip.

15. The dental floss of claim 1 wherein:
the floss tape comprises at least one side flossing fin extending laterally outwardly from each longitudinal side face of the flossing strip.

16. The dental floss of claim 15 wherein:
each of the side flossing fins extending laterally outwardly from each of the longitudinal side faces of the flossing strip extends laterally at an acute angle relative to a longitudinal edge of the flossing strip.

17. The dental floss of claim 16 wherein:
each of the side flossing fins extending laterally outwardly from each of the longitudinal side faces of the flossing strip extends laterally at an acute angle relative to a same longitudinal edge of the flossing strip.

18. The dental floss of claim 16 wherein:
each of the side flossing fins extending laterally outwardly from each of the longitudinal side faces of the flossing strip extends laterally at an acute angle relative to a different longitudinal edge of the flossing strip.

19. The dental floss of claim 1 wherein:
the floss tape comprises a plurality of flossing fins extending laterally outwardly from each longitudinal side face of the flossing strip.

20. Dental floss comprising:
a floss tape comprising a flossing strip, the flossing strip having opposing longitudinal side faces and opposing longitudinal edges, and at least one side flossing fin extending laterally outwardly from at least one of the longitudinal side faces of the flossing strip.
